(19) United States
(12) Patent Application Publication
(10) Pub. No.: US 2003/0191724 A1
(43) Pub. Date: Oct. 9, 2003

(54) System and method to facilitate the pricing of freight transportation services

(76) Inventors: Marco L. Turra, Jacksonville, FL (US); Noel L. Perry, Jacksonville, FL (US); James L. Shefelbine, Jacksonville, FL (US); Barbara R. Tilka, Jacksonville Beach, FL (US); Vicki L. Burton, Jacksonville, FL (US); John R. Couch, Jacksonville, FL (US); Thomas J. Schoenleben, Ponte Vedra Beach, FL (US)

Correspondence Address: MARK J. YOUNG, 50 N. LAURA STREET, SUITE 3300, JACKSONVILLE, FL, 32202, US

(21) Appl. No.: 10/116,200

(22) Filed: Apr. 3, 2002

(51) Int. Cl. G06G 7/00

(52) U.S. Cl. 705/400

(57) ABSTRACT

A computer-implemented method of facilitating the pricing of freight transportation services entails receiving information to compute pricing benchmarks from which a suggested price may be selected. The information may include, e.g., the commodity to be transported, the origin and destination, the vehicle type, and whether the customer owns the vehicle. In some cases, the type of commodity will dictate the appropriate type of vehicle (e.g., a covered hopper railroad car). Additional information may include the customer's name, user's identification, date, shipment dates and other information related to the potential transaction. Benchmarks may be computed based on the aforementioned information, historical data and pricing guidelines. The benchmarks account for best current rates, the amount a competitor would charge for transporting the commodity, costs, a minimum financial return, a desired profit, and historic rates per mile for the relevant commodity. The benchmarks, which may be computed in any order and according to various formulae so long as they establish desired limits for pricing, are used to determine a suggested price that is competitive, provides a desired financial return and does not cannibalize any existing traffic.

### FIELD OF THE INVENTION

This invention relates to pricing. More particularly, this invention relates to a system and method to facilitate the pricing of freight transportation services, particularly rail freight transportation services.

### BACKGROUND

Today's freight transportation providers operate in a highly competitive marketplace, facing intense competition from other providers of the same and alternative modes of freight transportation services. To compete effectively they must provide their customers with high quality services at a good price, which preferably covers costs and contributes to a reasonable measure of profitability.

Railroads, for example, compete against each other and against trucks and barges. Pricing managers price railroad services for customers by performing market and competitive analysis for individual business opportunities. They typically strive to account for competition while pricing services to cover variable costs, realize varying contributions (“contribution” is a measure of profitability that is widely used in the railroad industry and other capital intensive industries) to fixed costs, and achieve a measure of profitability.

Though pricing managers serve an important role, their conventional pricing methodologies are imprecise and not responsive to the fast pace of today's economy. As an initial matter, conventional pricing methods tend to be slow because pricing managers perform ad-hoc manual analysis for each opportunity. Additionally, as each pricing manager may interpret senior management strategic intent uniquely and apply market and competitive factors differently in their subjective judgment, the methods tend to be fragmented and inconsistent. Furthermore, analyses are often incomplete, especially for large bid packages, because pricing managers do not have sufficient resources or time to analyze all available data and many variables that may affect pricing. Moreover, such a system is slow to respond to changes in existing rate structures, because it requires each pricing manager to become informed and adjust pricing methodologies accordingly.

A computer-implemented system and method that provide a consistent framework for objectively pricing freight transportation services in accordance with a customized set of criteria would be advantageous, especially if prices are suggested based on existing traffic volumes, profitability, product substitution, competition and capacity. Such a system could substantially reduce risks of losing potential business and under-pricing, while providing favorable pricing to attract new business.

### SUMMARY

The present invention provides a system and consistent methodology to facilitate the pricing of freight transportation services, particularly rail freight transportation services, that entails receiving individual company-selected information to compute pricing benchmarks from which a suggested price may be selected. Each company using the system creates its customized pricing profile that includes information it deems most important for its pricing structure. The information may include the type and quantity of commodity to be transported, as well as the origin, destination, type of vehicle, container or other transportation equipment (e.g., a type of railroad car, container, truck or trailer) as applicable (collectively “vehicle”) and ownership of the vehicle. In the case of pricing rail freight transportation services, such information may include the railroad car type and whether the customer owns the car. In some cases, the type of commodity will dictate the appropriate type of railroad car. Additional information may include the customer's name, user's identification, date, shipment dates and other information related to the potential transaction. Benchmarks may be computed based on the aforementioned information, historical data and pricing guidelines. The benchmarks account for best current rates, the amount a competitor would charge for transporting the commodity, costs, a minimum financial return, a desired profit, and historic rates per mile for the relevant commodity. The benchmarks, which may be computed in any order and according to various formulae so long as they establish desired limits for pricing, are used to determine a suggested price that is competitive, provides a desired financial return and does not cannibalize any existing traffic.

It is therefore an object of the present invention to provide a system and method for facilitating the pricing of freight transportation services that entails receiving specified information to compute pricing benchmarks from which a suggested price may be selected.

It is another object of the invention to provide a system and method for facilitating the pricing of freight transportation services that entails receiving information to compute pricing benchmarks from which a suggested price may be selected, wherein the received information may include the commodity to be transported, the origin and destination, the equipment type, and ownership of the equipment.

It is also another object of the invention to provide a system and method for facilitating the pricing of freight transportation services that entails receiving information to compute pricing benchmarks from which a suggested price may be selected, wherein the pricing benchmarks may be computed based on the aforementioned information, available historical data and pricing guidelines.

It is yet another object of the invention to provide a system and method for facilitating the pricing of freight transportation services that entails receiving information to compute pricing benchmarks from which a suggested price may be selected, wherein the pricing benchmarks account for best current rates, the amount a competitor would charge for transporting the commodity, costs, a minimum financial return, a desired profit, and historic rates per mile for the relevant commodity.

It is a further object of the invention to provide a system and method for facilitating the pricing of freight transportation services that entails receiving information to compute pricing benchmarks from which a suggested price may be selected, wherein the pricing benchmarks, which may be computed in any order and according to various formulae so long as they establish desired limits for pricing, are used to determine a suggested price that is competitive, provides a desired financial return and does not cannibalize any existing traffic.

### BRIEF DESCRIPTION OF THE DRAWINGS

The foregoing and other objects, features and advantages of the present invention will become better understood with reference to the following description, appended claims, and accompanying drawings, where:

FIG. 1 conceptually depicts an exemplary computer system for implementing a system and methodology to facilitate pricing of freight transportation services in accordance with a preferred implementation of the present invention;

FIG. 2 is a flowchart conceptually depicting steps of a method for facilitating the pricing of freight transportation services in accordance with a preferred implementation of the present invention;

FIG. 3 is a drawing conceptually depicting sorted benchmarks, related information and rules for determining a suggested price in accordance with a preferred implementation of the present invention;

FIG. 4 is a drawing conceptually displaying a suggested price and a plurality of benchmarks in accordance with a preferred implementation of the present invention;

FIG. 5 is a screen display conceptually depicting a suggested price, plurality of benchmarks and related data in accordance with an implementation of the present invention;

FIG. 6 is a first part of a list of input variables and data in accordance with an implementation of the present invention; and

FIG. 7 is a second part of a list of input variables and data in accordance with an implementation of the present invention.

### DETAILED DESCRIPTION

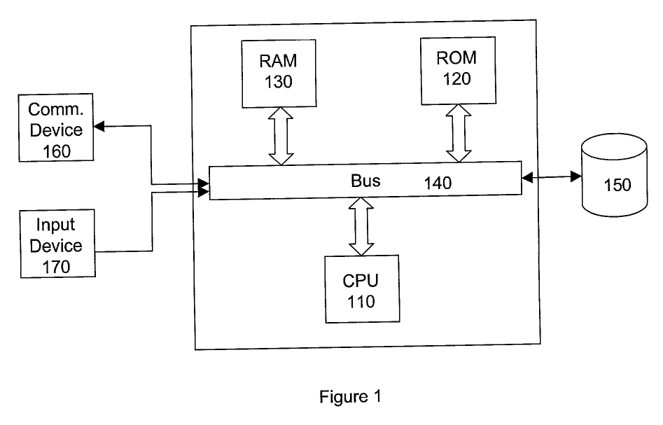

FIG. 1 conceptually shows an exemplary computer system for implementing a system and methodology to facilitate the pricing of rail freight transportation services in accordance with a preferred implementation of the present invention. The computer system includes a bus 140 for communicating information, a central processing unit (CPU) 110, a read only memory (ROM) 120, random access memory (RAM) 130, a storage device 150, a communications device 160 and an input device 170. The storage device may include a hard disk, CD-ROM drive, tape drive, memory and/or other mass storage equipment. These elements are typically included in most computer systems and particularly computer servers, and the aforementioned system is intended to represent a broad category of systems capable of being programmed to perform the methodology in accordance with a preferred implementation of the present invention. Of course, the system may include fewer, different and/or additional elements, provided it is capable of performing the method of facilitating the pricing of rail freight transportation services in accordance with the present invention. For example, the system may include multiple CPUs, a display device, and various input and output devices. Additionally, the system may alone perform the methodology or operate in a distributed environment to perform the method in accordance with a preferred implementation of the present invention. A user may access the computer system directly using an input device or remotely via a dial-up or network connection.

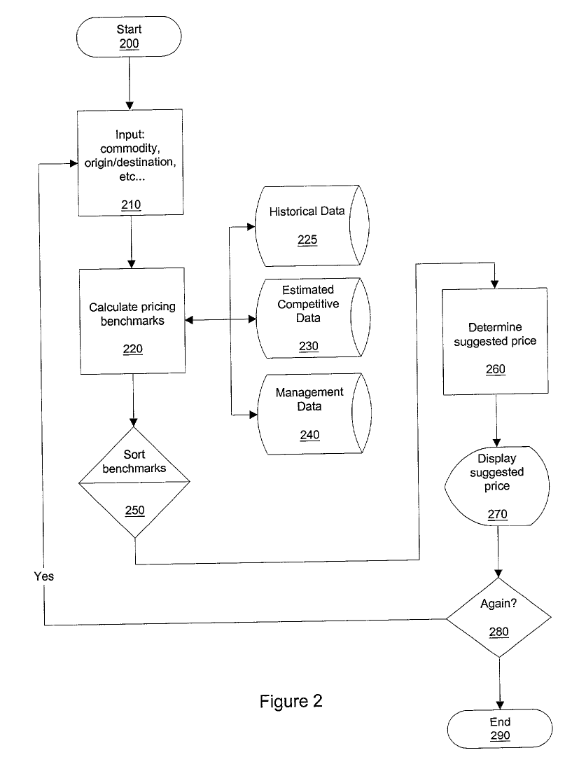

FIG. 2 shows a high-level flowchart that conceptually depicts steps of a method of facilitating the pricing of freight transportation services in accordance with a preferred implementation of the present invention. An initial step 210 entails inputting information to compute benchmarks, from which a suggested price may be selected. Preferably, the information includes the type and quantity of the commodity to be transported, the origin and destination, the vehicle container type, and ownership of the vehicle or container. Commodities are preferably identified using Standard Transportation Commodity Classification (STCC) Codes published by the Association of American Railroads <www.aar.org>, as such codes are typically used in databases of rail transactions. To facilitate the selection of a code, a search tool and/or link to a list of available codes and commodity descriptions may be provided. In some cases, the type of commodity may dictate the appropriate type of vehicle or container. Additional information may include the customer's name, user's identification, date, shipment dates and other information related to the potential transaction.

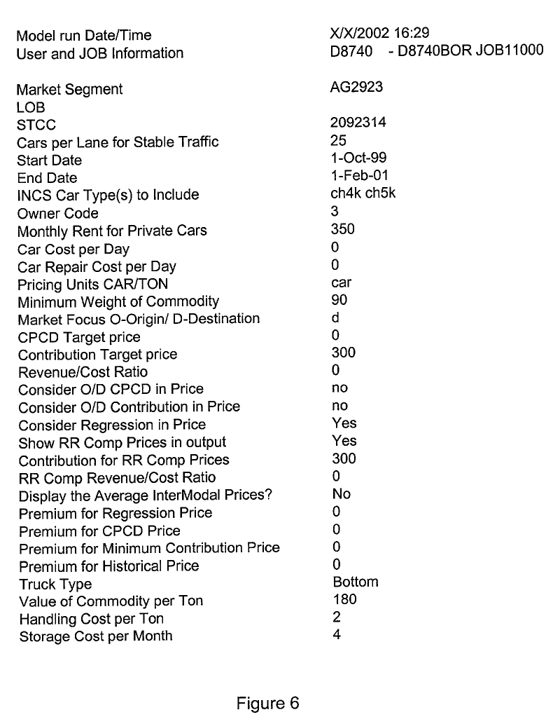

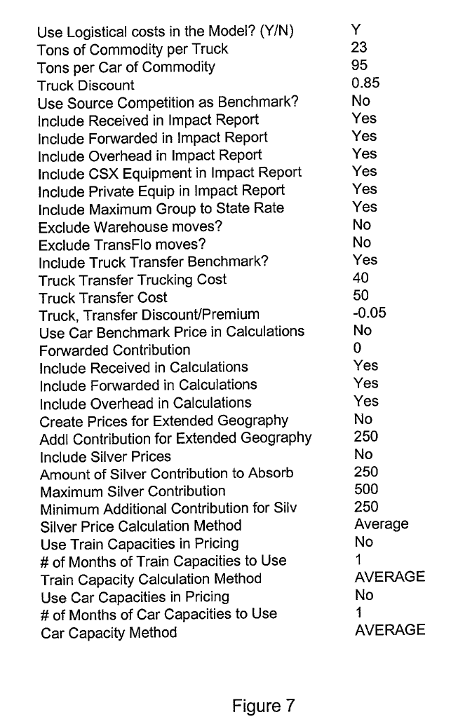

For example, referring to the exemplary lists of input provided in FIGS. 6 and 7 for pricing rail freight transportation services, such other information may include data identifying the relevant market segment and line of business to enable comparisons with traffic involving similar commodities and analyses of potential substitute commodities. Such information may also be used to identify the transaction as stored for purposes of future research and analysis.

The input may also include specifications for historical data to be used in determining benchmarks. For example, a date range may be specified to define the time period during which prior traffic may be considered relevant for benchmark determinations. Likewise, a minimum traffic volume may be specified in terms of cars per lane or cars per haul to define traffic of significance for consideration in benchmark determinations. Additionally, car types may be specified to further define traffic that may be considered relevant in determining certain benchmarks.

Additionally, the input may include financial data such as various contribution, premium, revenue and cost data. For instance, along with car ownership data, car costs may be used to determine what car related cost, if any, should be factored into certain benchmark computations. A customer supplying its own car or a third party's car would not be charged by the railroad for use of the car. Such data may be established by management directive, supply and demand for cars and/or determined from historical data. As an alternative to manually entering such data for each pricing determination, default values may be stored, such as in a database or initialization file, for use (unless overridden) in each pricing determination.

Next, various benchmarks are computed, as in step 220, based on input from step 210, historical data 225, estimated competitive data 230, and management data 240. The historical data 225 preferably include information pertaining to current and past traffic such as customer information, origins, destinations, paths, commodity, car type, price and duration. Freight transportation companies typically maintain databases of historical data in the ordinary course of business. Estimated competitive data 230 preferably includes information pertaining to costs and pricing for competitors based on origins, destinations, commodity, vehicle type and ownership. Such estimated competitive data may be derived from published information and/or commercially available databases known in the art. Management data 240 preferably includes information pertaining to costs, a minimum financial return, desired contributions, premiums and the like, as determined by management directive. While FIG. 2 conceptually shows three discrete sources for the historical, competitor and management data, they may be combined into fewer or divided into a greater number of sources. Additionally, some of the information may be derived from one or more databases or similar data sources, while other such information may be manually entered.

The benchmarks are reference values for determining a suggested price. Preferably, they are designed to account for best current rates, the amount a competitor would charge for transporting the commodity (e.g., via truck or rail), costs, a minimum financial return, a desired profit, and historic rates per mile for the relevant commodity. Thus, the benchmarks may be used to determine a suggested price that is competitive, economically sound and does not cannibalize existing traffic. They may be computed in any order and according to various formulae, so long as they establish desired limits for pricing.

In a preferred implementation of the present invention, some benchmarks may be computed for each “geographic pricing group” in a transportation network. Each geographic price group represents a distinct geographic region in the transportation network that may include a group of stations that serve as an origin or destination for shipments at the same price. For example, the CSX Transportation railroad network, which currently includes approximately 84 geographic pricing groups (excluding short lines), will have 84×84=7056 combinations. The Jacksonville, Fla. geographic pricing group of the CSX Transportation network, currently includes approximately 108 distinct stations in the northeast Florida and southeast Georgia areas.

In a preferred implementation, a benchmark that accounts for the best current rates is computed. In the case of rail freight transportation, the benchmark is based on current best rates for the commodity and car type under consideration that are currently utilized to move traffic. Rates may be considered current for a defined period of time, such as a year or six months. Current best rates are computed for each geographic pricing group in the railroad network served. The best current rates benchmark is the highest average rate between two stations within a geographic pricing group that recorded a minimum number of carload moves during the time frame indicated by the user. Additionally, a premium may be added to improve the economics of a move. This benchmark isolates the impact of prices based on a specific market segment, car type, car ownership and traffic class, and ensures that a suggested price is not less than current best rates.

A best current rates benchmark may similarly be computed for pricing other modes of freight transportation. In the trucking industry, for example, the benchmark may be based on current best rates for the commodity and truck type under consideration. In the shipping industry, the benchmark may be based on current best rates for the commodity and container type under consideration.

In a preferred implementation, one or more benchmarks based on competing alternative modes of transportation is also computed. In the case of rail freight transportation, for example, a truck benchmark may be computed. The benchmark is based on actual or estimated rates a truck would charge for moving the commodity from origin to destination. Databases of truck rates are commercially available and known in the art. Because rail typically takes longer and may involve greater logistical costs than delivery by truck, the truck benchmark is preferably discounted to account for the time and logistical costs. Thus, the truck benchmark may equal the trucking amount minus logistical costs and minus a discount. In a preferred implementation, logistical costs and the discount typically equal approximately fifteen percent of the estimated truck rate. While the logistical cost or the discount may be set at zero, preferably a combined amount (logistical cost plus discount) that is sufficient to offset any additional time and logistical costs typically attributed to rail is deducted from the truck amount. This benchmark helps to determine if a suggested price is competitive with an alternative mode of transportation. A similar benchmark may be computed for any alternative mode of transportation (e.g., barge, air and shipping) where they are competitive with rail).

Truck Benchmark=Truck Amount−Logistic Cost−Discount Eq. 1.

In certain markets, rail transportation can command a higher price than truck transportation. For example, in the wheat middling market, rail cars may be loaded over the weekend when trucks are typically unavailable. In such a case, logistical costs and/or a discount might not be deducted from the truck amount, or a premium can be added.

A benchmark based on competing alternative modes may be similarly computed for pricing other modes. In the trucking industry, for example, the benchmark may be based on actual or estimated rates a railroad or barge would charge for moving the commodity from origin to destination, preferably adjusted to account for differences between respective delivery times and logistical costs.

A minimum equipment financial return benchmark is also computed in a preferred implementation. This benchmark is based on estimated cost plus a financial target. In the case of rail freight transportation, “costs” may be calculated before including car costs (“Cost BCC”), e.g., all variable costs (except car cost), such as fuel, locomotive, track and crew costs. The financial target is preferably a contribution per car day (“CPCD”) multiplied by a cycle, where the cycle is an amount of time (in days and fractions thereof) to at least complete the move, and may include the time to move the car from origin to destination and to its next origin, or from its previous destination to current origin and current destination. Management typically sets the contribution for each particular car type. The Cost BCC and CPCD may be derived from a data source, such as 225-240 in FIG. 2, or manually entered as in step 210 in FIG. 2. This benchmark ensures that a price covers key costs and makes a desired contribution to profitability.

Min. Equip. Financial Return Benchmark=BCC+CPCD×Cycle Eq. 2.

A minimum equipment financial return benchmark may similarly be computed for pricing other modes of freight transportation. In the trucking industry, for example, the costs may include a truck cost and all variable costs such as fuel and driver costs. The contribution component may be a contribution per truck day, and the cycle may be the time in days to at least complete the move and possibly position the truck for its next move.

Additionally, a market price benchmark is computed in a preferred implementation. In the case of rail freight transportation, this benchmark is based on the length of haul and the prices for similar moves for the same commodity (or commodities that can be substituted by the customer in its production processes), car type and car ownership, computed from historical data for each geographic pricing group in the railroad network served. The benchmark preferably accounts for current and past traffic over a determined period of time, e.g., one year back from the date of pricing. The benchmark, for each geographic pricing group (i) in the railroad network served, preferably equals the product of the length of the haul being priced (Length) and the price for the current or past haul (Priceᵢ) divided by the length of the current or past haul (Lengthᵢ), plus a premium. The resulting array of benchmarks thus applies the historic rates per mile by market (based on commodity) to the haul being priced. A premium may be added to improve the economics of a move. This benchmark may also be capped to the Truck Benchmark, to maintain competitiveness of a suggested price and reduce the risk of losing traffic. Based on a specific market segment, car type, car ownership and traffic class, this benchmark isolates prices and ensures that a suggested price is comparable to historic rates.

Market Price Benchmark=Length×Priceᵢ/Lengthᵢ+Premium Eq. 3.

A market price benchmark may similarly be computed for pricing other modes of freight transportation. In the trucking industry, for example, the benchmark may be based on the distance traveled for the move and the prices and distance traveled for similar moves for the same commodity, truck type and truck ownership, computed from historical data.

A contribution benchmark is also computed in a preferred implementation. In the case of rail freight transportation, this benchmark is based on the highest contribution (i.e., profit) for similar moves for the same commodity, car type and car ownership, determined from historical data for each geographic pricing group in the railroad network served. The benchmark preferably accounts for current and past traffic over a determined period of time, e.g., one year back from the date of pricing. The highest contribution is then used to compute a contribution benchmark for all combinations of possible shipping and receiving points for the haul being priced. The contribution benchmark for each combination preferably equals cost plus the highest contribution. A premium may also be added to improve the economics of the move. This benchmark protects a measure of profitability for an entire move.

Contribution Benchmark=Cost+Contribution_{highest}+Premium Eq. 4.

A contribution benchmark may similarly be computed for pricing other modes of freight transportation. In the trucking industry, for example, the benchmark may equal cost plus the highest contribution for similar moves for the same commodity, truck type and truck ownership, determined from historical data. A premium may also be added to improve the economics of the move.

A contribution per car day (CPCD) benchmark is also computed for pricing rail freight transportation services in a preferred implementation. This benchmark, which is similar to the contribution benchmark, but accounts for contribution on a daily basis, is based on the highest contribution (i.e., profit) per car day, after car cost (CPCDACC), for similar moves for the same commodity, car type and car ownership, determined from historical data for each geographic pricing group in the railroad network served. The benchmark preferably accounts for current and past traffic over a determined period of time, e.g., one year back from the date of pricing. The highest contribution per car day is then used to compute a contribution benchmark for all combinations of possible shipping and receiving points for the haul being priced. The contribution per car day benchmark for each combination preferably equals cost plus the product of the highest contribution per car day and the cycle. The cycle preferably equals the time in days and fractions thereof for each combination of possible shipping and receiving points for the haul being priced. A premium may also be added to improve the economics of the move. This benchmark protects profitability per car day for a move.

CPCD Benchmark=Cost+CPCDACC×Cycle+Premium Eq. 5.

A contribution per vehicle day may similarly be computed for pricing other modes of freight transportation. In the trucking industry, for example, the benchmark may equal cost plus the product of highest contribution per truck day after truck cost and the cycle. Again, a premium may be added to improve the economics of a move.

A car type benchmark may also be computed for pricing rail freight transportation services in a preferred implementation. The benchmark is based on best (highest) prices for moving a particular car type, (including ownership) for all commodities by lane, determined from historical data for each geographic pricing group in the railroad network served. A vehicle type benchmark may similarly be computed for pricing other modes of freight transportation based on the best prices for moving a particular truck, barge or container as the case may be. It is preferably used as a reference value, but may also be used to determine pricing depending upon pricing objectives, in particular for pricing commodities never previously handled by the user.

A rail competition benchmark may also be computed in a preferred implementation. The benchmark is based on an estimate of a rail competitor's contribution, which can be estimated from the competitor's published prices and/or the pricing railroad's own contribution. It preferably equals the product of cost and a circuitry factor plus the rail competitor's expected contribution, with the cost being the total cost of the haul being priced. The circuitry factor is the ratio of the competitor's length of haul to the length of haul being priced. The rail competition benchmark may be used to determine a competitive price and decide a profitability target for competitive pricing. A similar benchmark may likewise be computed for pricing other modes of freight transportation based on an estimate of a price or contribution of a competitor that provides the same mode of freight transportation.

Rail Competition Benchmark=Cost×Circuitry Factor+Contribution_{Competitor's} Eq. 6.

A source competition benchmark may also be computed in a preferred implementation. The benchmark is based on a truck price from the closest sourcing point (origin) to the consumption location. Databases of truck rates are commercially available and known in the art. This estimated truck price may then be used to assess competitiveness of the rail estimated price from the actual sourcing point, and possibly to decide a profitability target for competitive pricing. A similar benchmark may likewise be computed for pricing other modes of freight transportation based on the closest sourcing point (origin) to the consumption location.

Yet another benchmark that may be computed in a preferred implementation is a network capacity benchmark. This benchmark may be based on the earning profile of each traffic lane (i.e., each combination of two geographic pricing groups) and a profitability target given capacity constraints of the lane.

Still another benchmark that may be computed in a preferred implementation is an equipment availability benchmark. This benchmark may be based on the availability of rail cars (or other vehicles in the case of pricing other modes of freight transportation) and set profitability targets to improve or optimize return on equipment.

Other benchmarks representative of costs, contributions, premiums and competitiveness may be employed in addition to or in lieu of some or all of the foregoing benchmarks, and come within the scope of the present invention. For example, a benchmark representative of the lowest competitor's price discounted by a pre-determined percentage may be used, and clearly and comes within the scope of the present invention. Likewise, a benchmark representative of certain financial minimums per lane may be used, and also comes within the scope of the present invention. However, in a preferred implementation, at least a benchmark representative of a competitor's price and a benchmark representative of a minimum financial return are used.

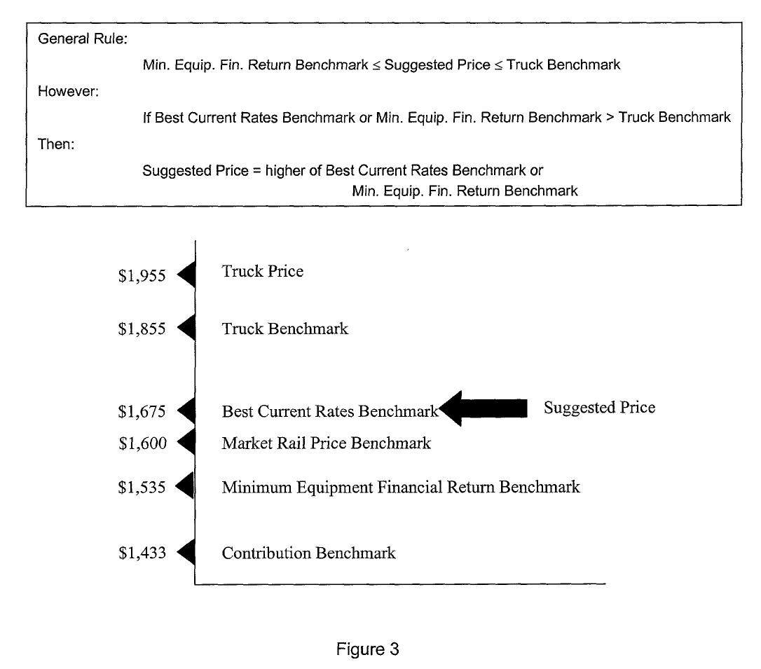

After the benchmarks have been calculated, they are preferably sorted as in step 250. Referring now to FIG. 3, a plurality of benchmarks and related information are shown for pricing rail freight transportation services, with the benchmarks arranged in ascending order. Sorting is particularly useful for displaying the benchmarks in ascending order and illustrating the determination of a suggested price.

After the benchmarks have been sorted, a suggested price is determined in accordance with rules as in step 260. The suggested price should generally be below a competition benchmark (e.g., the truck benchmark for rail freight transportation) and higher than the minimum equipment financial return benchmark and best current rates benchmark. In general, the suggested price will be an amount equal to or higher than the highest benchmark that is below the competition benchmark. However, if best current rates and/or minimum equipment financial return benchmarks are computed, and either such benchmark exceeds the competition benchmark, then the suggested price preferably equals the higher of the best current rates benchmark or the minimum equipment financial return benchmark.

Alternatively, if no best current rates benchmark is available to price a move, and if the minimum equipment financial return benchmark exceeds a competition benchmark, the suggested price may equal the competition benchmark. Such a suggested price extracts as much value from a potential move as possible while remaining competitive.

Other rules representative of the profitability and competitiveness of a price may be employed. For example, rules that determine a suggested price equal to or slightly below a benchmark representative of the lowest competitor's price, provided that the price meets certain financial minimums, may be used, and clearly and come within the scope of the present invention. Likewise, rules that determine a suggested price equal to or higher than a benchmark representative of certain financial minimums, provided that price does not exceed a competitor's price, may be used, and clearly and come within the scope of the present invention. The rules may also disqualify or ignore certain benchmarks, based on the commodity, customer, vehicle type, or other criteria.

The methodology and system of the present invention are extremely flexible. There are many ways to calculate suitable benchmark or similar pricing reference values. There are also many ways to determine a suggested price based on the benchmarks or reference values. Thus, an advantage of the present invention is that it may be tailored to accommodate the priorities, available data and business processes of a particular freight transportation provider.

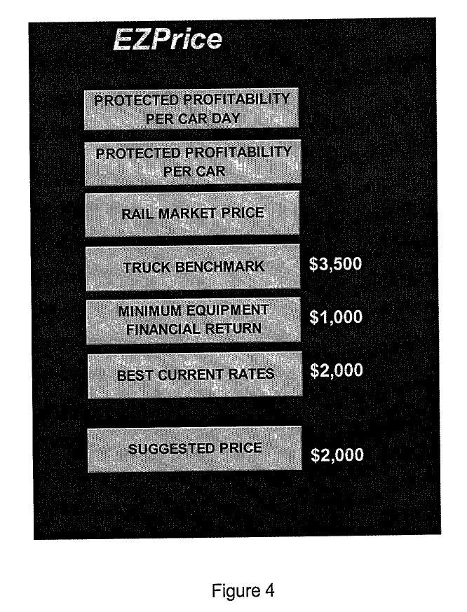

After determining a suggested price, the amount is preferably displayed to a user, as in step 270. Referring now to FIG. 4, a drawing conceptually displaying a suggested price and a plurality of benchmarks for pricing rail freight transportation services is shown, including values for selected benchmarks. The suggested price of $2,000 is greater than the minimum equipment financial return benchmark of $1,000, but less than the truck benchmark of $3,500, ensuring a competitive price that covers key costs and makes a desired contribution to profitability.

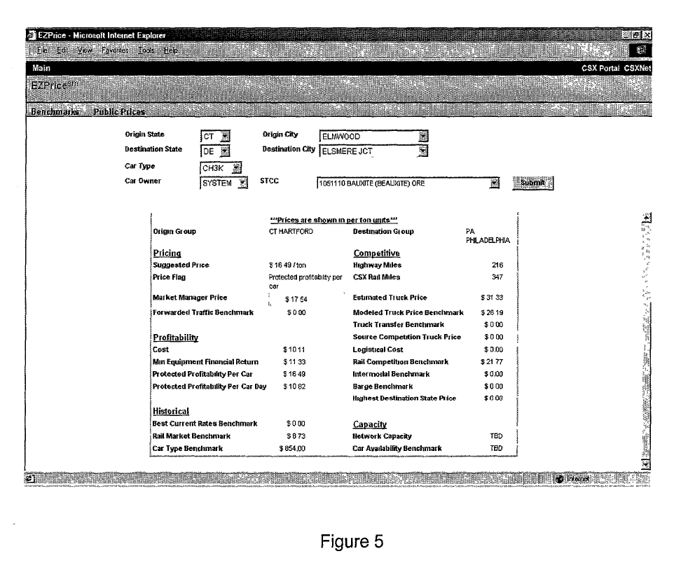

Referring now to FIG. 5, a screen display conceptually depicting a suggested price, plurality of benchmarks and related data in accordance with an implementation of the present invention for pricing rail freight transportation services is shown. The suggested price is $16.49 per ton, but the market (pricing) manager has entered a price of $17.54. The suggested price is based on a protected profitability per car benchmark (i.e., the contribution benchmark), which (along with the price entered by the market manager) is above the minimum equipment financial return benchmark of $11.33 but substantially below the truck benchmark of $28.19. The suggested price and the price entered by the market manager are also below a rail competition benchmark of $21.77. A user may select different values shown in the pop-up menus (indicated by rectangles with downward pointing arrows) to determine a new suggested price.

Next, a user may have the option of performing the methodology again, as in step 280. An affirmative response may return control to the input step 210.

The foregoing detailed description of particular preferred implementations of the invention, which should be read in conjunction with the accompanying drawings, is not intended to limit the enumerated claims, but to serve as particular examples of the invention. Those skilled in the art should appreciate that they can readily use the concepts and specific implementations disclosed as bases for modifying or designing other methods and systems for carrying out the same purposes of the present invention. Those skilled in the art should also realize that such equivalent methods and systems do not depart from the spirit and scope of the invention as claimed.

Having thus described the present invention, what is claimed as new and desired to be secured by Letters Patent is as follows:

1. A method for determining a suggested price for freight transportation services comprising steps of:
receiving commodity, quantity, origin and destination data for the freight transportation services,
calculating a plurality of pricing reference values, including a reference value representative of an estimated price of a competitor and a reference value representative of costs, said costs being estimated costs for rendering the freight transportation services, and
determining a suggested price, said suggested price being equal to or greater than the reference value representative of costs.

2. A method for determining a suggested price for freight transportation services as in claim 1, wherein the suggested price equals or is less than the reference value representative of an estimated price of a competitor.

3. A method for determining a suggested price for freight transportation services according to claim 1, wherein the step of calculating a plurality of pricing reference values further includes, calculating a reference value representative of a minimum financial return.

4. A method for determining a suggested price for freight transportation services according to claim 3, wherein the suggested price equals or is less than the reference value representative of an estimated price of a competitor, and the suggested price equals or exceeds the reference value representative of the minimum financial return.

5. A method for determining a suggested price for freight transportation services according to claim 3, wherein the reference value representative of the minimum financial return exceeds the reference value representative of an estimated price of a competitor, and the suggested price equals said reference value representative of an estimated price of a competitor.

6. A method for determining a suggested price for freight transportation services according to claim 3, wherein the step of calculating a plurality of pricing reference values further includes calculating a reference value representative of best current rates for transportation services substantially equivalent to the transportation services for which a price is being suggested.

7. A method for determining a suggested price for freight transportation services according to claim 6, wherein the suggested price:
a) equals or exceeds the reference value representative of best current rates for transportation services substantially equivalent to the transportation services for which a price is being suggested; and
b) equals or is less than the reference value representative of an estimated price of a competitor; and
c) equals or exceeds the reference value representative of the minimum financial return.

8. A method for determining a suggested price for freight transportation services according to claim 6, wherein the reference value representative of best current rates for transportation services substantially equivalent to the transportation services for which a price is being suggested exceeds the reference value representative of an estimated price of a competitor; and the suggested price equals the greater of the reference value representative of best current rates for transportation services substantially equivalent to the transportation services for which a price is being suggested or the reference value representative of the minimum financial return.

9. A method for determining a suggested price for freight transportation services according to claim 6, wherein the reference value representative of best current rates for transportation services substantially equivalent to the transportation services for which a price is being suggested and the reference value representative of the minimum financial return exceed the reference value representative of an estimated price of a competitor; and the suggested price equals the greater of the reference value representative of best current rates for transportation services substantially equivalent to the transportation services for which a price is being suggested or the reference value representative of the minimum financial return.

10. A method of determining a suggested price for rail freight transportation services comprising steps of:
receiving commodity, quantity, origin, destination and rail car type data for the rail freight transportation services,
calculating a truck benchmark and a minimum equipment financial return benchmark, and
determining a suggested price based on the benchmarks.

11. A method for determining a suggested price for rail freight transportation services as in claim 10, wherein the truck benchmark equals a truck amount, minus a logistic cost, minus a discount, said truck amount being an estimated amount charged for delivery of the quantity of the commodity from origin to destination by truck, said logistic cost being an estimated increased logistic cost for delivery by rail rather than by truck, and said discount being an amount equal to or greater than zero.

12. A method for determining a suggested price for rail freight transportation services as in claim 11, wherein the minimum equipment financial return benchmark equals the sum of a before car cost and a product of a contribution per car day and a cycle, said cycle being the time to move the rail car from the origin to the destination and to a next origin.

13. A method for determining a suggested price for rail freight transportation services as in claim 12, further including a step of calculating a best current rates benchmark.

14. A method for determining a suggested price for rail freight transportation services as in claim 13, wherein said suggested price is greater than or equal to the minimum equipment financial return benchmark, and less than or equal to the truck benchmark.

15. A method for determining a suggested price for rail freight transportation services as in claim 13, wherein said suggested price is equal to the higher of the best current rates benchmark or the minimum equipment financial return benchmark.

16. A method for determining a suggested price for rail freight transportation services according to claim 13, wherein the suggested price:
a) equals or exceeds the best current rates benchmark; and
b) equals or is less than the truck benchmark; and
c) equals or exceeds the minimum equipment financial return benchmark.

17. A method for determining a suggested price for rail freight transportation services according to claim 13, wherein the best current rates benchmark exceeds the truck benchmark; and the suggested price equals the greater of the best current rates benchmark or the minimum equipment financial return benchmark.

18. A method for determining a suggested price for rail freight transportation services according to claim 13, wherein the best current rates benchmark and the minimum equipment financial return benchmark exceed the truck benchmark; and the suggested price equals the greater of the best current rates benchmark or the minimum equipment financial return benchmark.

19. A method for determining a suggested price for rail freight transportation services as in claim 13, wherein:
if the best current rates benchmark and the minimum equipment financial return benchmark are less than or equal to the truck benchmark, then said suggested price is greater than or equal to the minimum equipment financial return benchmark, and less than or equal to the truck benchmark, and
if the best current rates benchmark or the minimum equipment financial return benchmark is greater than the truck benchmark, then said suggested price is equal to the higher of the best current rates benchmark or the minimum equipment financial return benchmark.

20. A method for determining a suggested price for rail freight transportation services as in claim 13, further including a step of calculating a market rail price benchmark.

21. A method for determining a suggested price for rail freight transportation services as in claim 20, further including a step of calculating a contribution benchmark.

22. A method for determining a suggested price for rail freight transportation services as in claim 21, further including a step of calculating a contribution per car day benchmark.

23. A method for determining a suggested price for rail freight transportation services as in claim 22, further including a step of calculating a rail competition benchmark.

24. A method for determining a suggested price for rail freight transportation services as in claim 23, further including a step of calculating a source competition benchmark.

25. A method for determining a suggested price for rail freight transportation services as in claim 24, further including a step of calculating a network capacity benchmark.

26. A method for determining a suggested price for rail freight transportation services as in claim 25, further including a step of sorting the benchmarks in ascending order.

27. A method for determining a suggested price for rail freight transportation services as in claim 26, wherein:
if the best current rates benchmark and the minimum equipment financial return benchmark are less than or equal to the truck benchmark, then said suggested price is equal to the highest benchmark that is greater than or equal to the minimum equipment financial return benchmark, and less than or equal to the truck benchmark, and
if the best current rates benchmark or the minimum equipment financial return benchmark is greater than the truck benchmark, then said suggested price is equal to the higher of the best current rates benchmark or the minimum equipment financial return benchmark.

28. A computer-implemented system for determining a suggested price for rail freight transportation services comprising:
means for receiving commodity, quantity, origin, destination and rail car type data for the rail freight transportation services,
means for calculating a truck benchmark, a best current rates benchmark and a minimum equipment financial return benchmark, and
means for determining a suggested price based on the benchmarks.

29. A system for determining a suggested price for rail freight transportation services as in claim 28, wherein the truck benchmark equals a truck amount, minus a logistic cost, minus a discount, said truck amount being an estimated amount charged for delivery of the quantity of the commodity from origin to destination by truck, said logistic cost being an estimated increased logistic cost for delivery by rail rather than by truck, and said discount being an amount equal to or greater than zero.

30. A system for determining a suggested price for rail freight transportation services as in claim 29, wherein the minimum equipment financial return benchmark equals the sum of a before car cost and a product of a contribution per car day and a cycle, said cycle being the time to move the rail car from the origin to the destination and to a next origin.

31. A system for determining a suggested price for rail freight transportation services as in claim 30, further including a step of calculating a best current rates benchmark.

32. A system for determining a suggested price for rail freight transportation services as in step 31, wherein:
if the best current rates benchmark and the minimum equipment financial return benchmark are less than or equal to the truck benchmark, then said suggested price is greater than or equal to the minimum equipment financial return benchmark, and less than or equal to the truck benchmark, and
if the best current rates benchmark or the minimum equipment financial return benchmark is greater than the truck benchmark, then said suggested price is equal to the higher of the best current rates benchmark or the minimum equipment financial return benchmark.
